(19) United States
(12) Patent Application Publication
(10) Pub. No.: US 2011/0002066 A1
(43) Pub. Date: Jan. 6, 2011

(54) ACTUATOR ARM AND DISK RECORDING DEVICE

(75) Inventors: Shinji KOGANEZAWA, Atsugi-shi (JP); Shinichi Ohtsuka, Saitama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Toshiba Storage Device Corporation, Tokyo (JP)

(21) Appl. No.: 12/814,384

(22) Filed: Jun. 11, 2010

(30) Foreign Application Priority Data
Jul. 2, 2009 (JP) 2009-158150

(51) Int. Cl. G11B 5/596

(52) U.S. Cl. 360/78.12; G9B/5.216

(57) ABSTRACT

According to one embodiment, an actuator arm includes a joint, an extension, a pair of outer surfaces, and a linear protrusion. The joint is rotatably supported on a shaft. The extension extends from the joint and has a tip end connected to a head that performs at least reading or writing with respect to a rotating disk recording medium. The outer surfaces are in a front-and-rear relationship with each other. At least one of the outer surfaces faces the disk recording medium. The linear protrusion is arranged on and extends along an edge of at least one of the outer surfaces. The edge is located upstream on the outer surfaces in a flowing direction of an air flow generated by the rotation of the disk recording medium.

### CROSS-REFERENCE TO RELATED APPLICATIONS

This application is based upon and claims the benefit of priority from Japanese Patent Application No. 2009-158150, filed Jul. 2, 2009, the entire contents of which are incorporated herein by reference.

### BACKGROUND

1. Field

One embodiment of the invention relates to an actuator arm and a disk recording device.

2. Description of the Related Art

In recent years, in disk recording devices, such as magnetic disk recording devices, in which data is written to a disk recording medium by a head, along with the increased recording density of the disk recording medium, high accuracy is required in head positioning to cause the head to move to a predetermined track. At the same time, improvement is also required in a data transfer rate at which data is read from or written to the disk recording medium. To improve the data transfer rate, the rotation speed of the disk recording medium is increased.

If the disk recording medium rotates faster, an air disturbance caused by an air flow disturbance generated by the rotation of the disk recording medium also increases to further increase an excitation force applied to an actuator arm due to the air flow. This influences the head positioning accuracy greatly.

Accordingly, there has been proposed a structure in which an air flow is controlled so that a detachment thereof around the actuator arm does not occur as further downstream as possible to reduce the excitation force applied to the actuator arm.

For example, Japanese Patent Application Publication (KOKAI) No. 2002-358743 discloses a disk recording device 200 comprising a plurality of dot-like protrusions 216a arranged on the surface of an actuator arm 216 that faces a disk recording medium 11 as illustrated in FIGS. 14 and 15. An arrow a in FIG. 14 indicates the direction of the rotation of the disk recording medium 11. An arrow b indicates a flowing direction of an air flow generated by the rotation of the disk recording medium 11. In FIG. 15, arrows indicate how the air flow flows when the disk recording medium 11 rotates.

There is a limitation on the improvement of the head positioning accuracy by only the protrusions 216a.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a disk recording device according to a first embodiment of the invention;

FIG. 2 is an exemplary cross-sectional view taken along a line II-II in FIG. 1 in the first embodiment;

FIG. 3 is an exemplary graph indicating experiment results related to the accuracy of head positioning by an actuator arm in the first embodiment;

FIG. 4 is an exemplary schematic diagram for explaining the experiment results related to the accuracy of the head positioning by the actuator arm in the first embodiment;

FIG. 5 is an exemplary schematic diagram of a disk recording device according to a second comparative example;

FIG. 6 is an exemplary cross-sectional view taken along a line XI-XI in FIG. 5;

FIG. 7 is an exemplary cross-sectional view of a modification of the second comparative example;

FIG. 8A is an exemplary cross-sectional view of an actuator arm according to a first modification of the first embodiment;

FIG. 8B is an exemplary cross-sectional view of an actuator arm according to a second modification of the first embodiment;

FIG. 8C is an exemplary cross-sectional view of an actuator arm according to a third modification of the first embodiment;

FIG. 8D is an exemplary cross-sectional view of an actuator arm according to a fourth modification of the first embodiment;

FIG. 9 is an exemplary cross-sectional view of an actuator arm according to a second embodiment of the invention;

FIG. 10 is an exemplary cross-sectional view of an actuator arm according to a third embodiment of the invention;

FIG. 11 is an exemplary cross-sectional view of an actuator arm according to a modification of the third embodiment;

FIG. 12 is an exemplary schematic diagram of a disk recording device according to a fourth embodiment of the invention;

FIG. 13 is an exemplary cross-sectional view taken along a line XIII-XIII in FIG. 12;

FIG. 14 is an exemplary schematic diagram of a conventional disk recording device; and

FIG. 15 is an exemplary cross-sectional view taken along a line XV-XV in FIG. 14.

### DETAILED DESCRIPTION

Various embodiments according to the invention will be described hereinafter with reference to the accompanying drawings. In general, according to one embodiment of the invention, an actuator arm comprises a joint, an extension, a pair of outer surfaces, and a linear protrusion. The joint is configured to be rotatably supported on a shaft. The extension extends from the joint and has a tip end connected to a head configured to perform at least one of reading and writing with respect to a rotating disk recording medium. The outer surfaces are configured to be in a front-and-rear relationship with each other. At least one of the outer surfaces is configured to face the disk recording medium. The linear protrusion is configured to be arranged on and extend along an edge of at least one of the outer surfaces. The edge is located upstream on the outer surfaces in a flowing direction of an air flow generated by the rotation of the disk recording medium.

According to another embodiment of the invention, a disk recording device comprises a disk recording medium, a disk driving source, a head, an actuator arm, and an arm driving source. The disk driving source is configured to drive the disk recording medium to rotate. The head is configured to perform at least one of reading and writing with respect to the rotating disk recording medium. The actuator arm is configured to be connected to the head. The arm driving source is configured to drive the actuator arm to rotate. The actuator arm comprises a joint, an extension, a pair of outer surfaces, and a linear protrusion. The joint is configured to be rotatably supported on a shaft. The extension extends from the joint. The outer surfaces are configured to be in a front-and-rear relationship with each other. At least one of the outer surfaces is configured to face the disk recording medium. The linear protrusion is configured to be arranged on and extend along an edge of at least one of the outer surfaces. The edge is located upstream on the outer surfaces in a flowing direction of an air flow generated by the rotation of the disk recording medium.

In the following, like reference numerals refer to like parts, and the same description is not repeated.

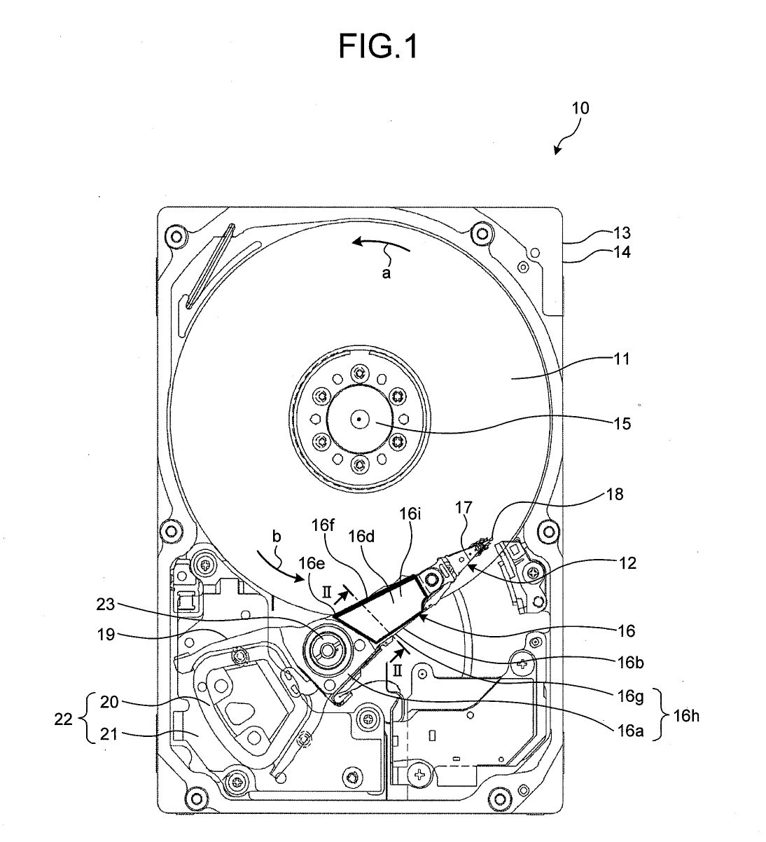

FIG. 1 is a schematic diagram of a disk recording device according to a first embodiment of the invention. As illustrated in FIG. 1, a disk recording device 10 comprises the disk recording medium 11 storing data, a head assembly 12, and a housing 13 housing the disk recording medium 11 and the head assembly 12. For convenience of description, it is herein assumed that the radial direction of the disk recording medium 11 is horizontal, and the direction perpendicular to the front and the rear surfaces of the disk recording medium 11 is vertical; however, the installation of the disk recording device 10 is not limited thereto.

The housing 13 comprises a bottomed box-shaped base member 14 having an opening on the top, and a cover (not illustrated) covering the opening of the base member 14.

The disk recording medium 11 may be, for example, a magnetic disk recording medium. The disk recording medium 11 may be stacked in a plurality of layers, or may be only one. In the drawings, an example is illustrated in which the disk recording medium 11 is arranged in a plurality of layers. The disk recording medium 11 is connected to a spindle motor 15 in the housing 13, and is driven to rotate by the spindle motor 15. The spindle motor 15 is a disk driving source that drives the disk recording medium 11 to rotate. The direction in which the disk recording medium 11 rotates is indicated by an arrow a in FIG. 1. The rotating disk recording medium 11 generates an air flow. The flowing direction of the air flow is indicated by an arrow b.

The head assembly 12 comprises a plurality of actuator arms 16 and a head 18 connected to a tip end of each of the actuator arms 16 via a suspension 17. A coil support 19 is arranged at the opposite end of the head assembly with respect to the head 18, and holds a coil 20. The coil 20 functions as an arm driving source 22, together with a stator 21 fixed on the base member 14, for driving the actuator arms 16 to rotate. The head assembly 12 is rotatably supported on a shaft 23, and driven by the arm driving source 22 to rotate about the shaft 23.

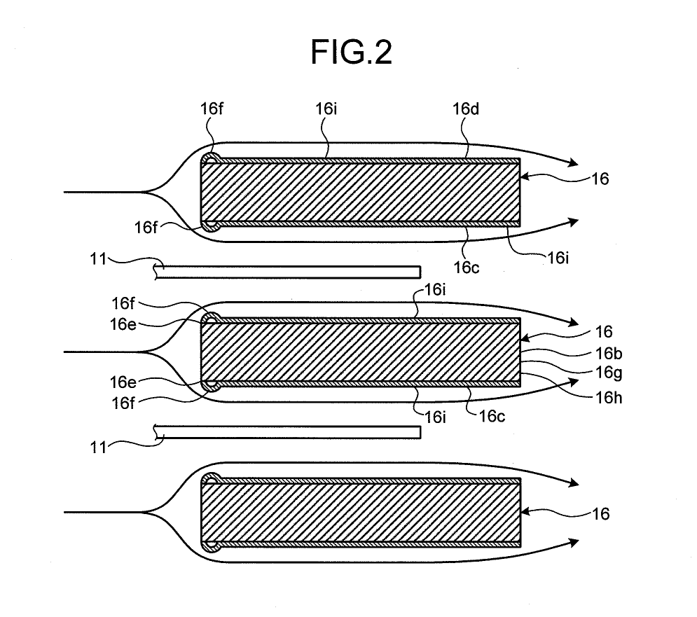

FIG. 2 is a cross-sectional view taken along a line II-II in FIG. 1. As illustrated in FIGS. 1 and 2, the actuator arm 16 has a joint 16a that is rotatably supported about the shaft 23, an extension 16b extending from the joint 16a, and a linear protrusion 16f provided to the extension 16b. The actuator arms 16 are in a front-and-rear relationship with each other, and have a pair of outer surfaces 16c and 16d at least one of which faces the disk recording medium 11. The outer surfaces 16c and 16d are formed at least on the extension 16b in the actuator arm 16. The outer surfaces 16c and 16d extend substantially along the front and back surfaces of the disk recording medium 11 to form the bottom and top surfaces of the actuator arm 16. The outer surfaces 16c and 16d are connected to each other on the left and right side surfaces.

The head 18 is connected to the tip end of the extension 16b via the suspension 17. The extension 16b moves in a direction traversing the tracks on the disk recording medium 11 by the driving force of the arm driving source.

The linear protrusions 16f are arranged along edges 16e of the outer surfaces 16c and 16d. The edges 16e are located upstream on the outer surfaces 16c and 16d in the direction of an air flow generated by the rotation of the disk recording medium 11. The linear protrusion 16f extends along the edge 16e. More specifically, the linear protrusion 16f is formed to extend from a base end of the extension 16b to near a tip end thereof, and is arranged one on each of the outer surfaces 16c and 16d. The linear protrusions 16f need not necessarily arranged on both the outer surfaces 16c and 16d, and may be arranged on at least one of the outer surfaces 16c and 16d.

More specifically, the extension 16b has a base body 16g and plate members 16i that are fixed onto the base body 16g. The base body 16g is formed integrally with the joint 16a, forming an arm main body 16h together with the joint 16a. Each of the plate member 16i is a thin steel plate member such as an aluminum plate or a stainless steel (SUS304) plate. The thickness of the plate member 16i is, for example, 50 micrometers. The plate members 16i are affixed to the top and bottom surfaces of the base body 16g with a viscoelastic material. The linear protrusions 16f are formed integrally with the plate members 16i. More specifically, edges of the plate members 16i are bent in a substantially semi-circular shape, in a cross-section thereof, to realize the linear protrusions 16f. The height of the linear protrusion 16f is preferably within a range of 50 to 200 micrometers. From the perspective of improving the positioning accuracy of the head 18, it is preferable to affix the plate member 16i on which the linear protrusion 16f is arranged to the entire area of the top and bottom surfaces of the arm main body 16h.

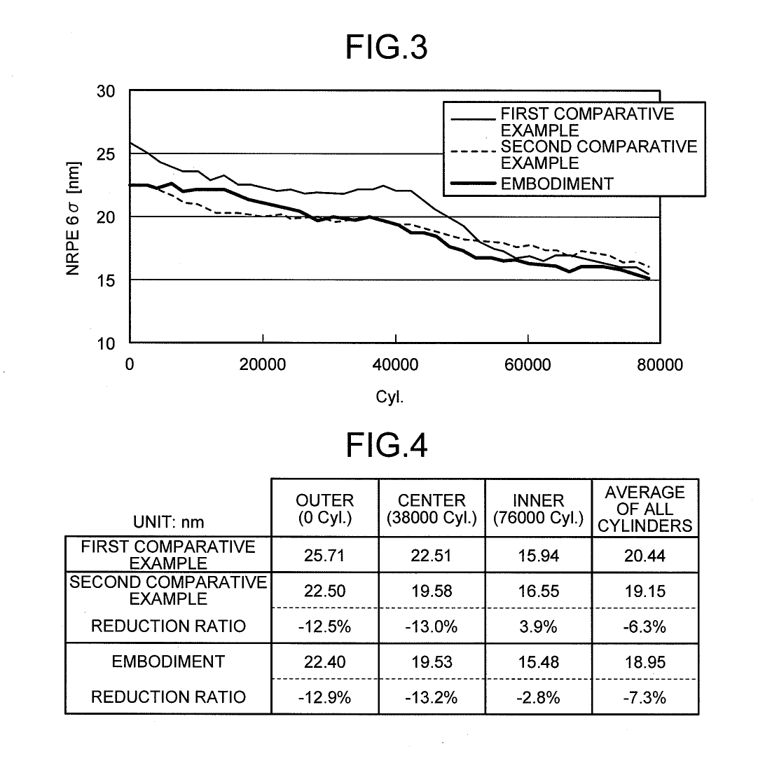

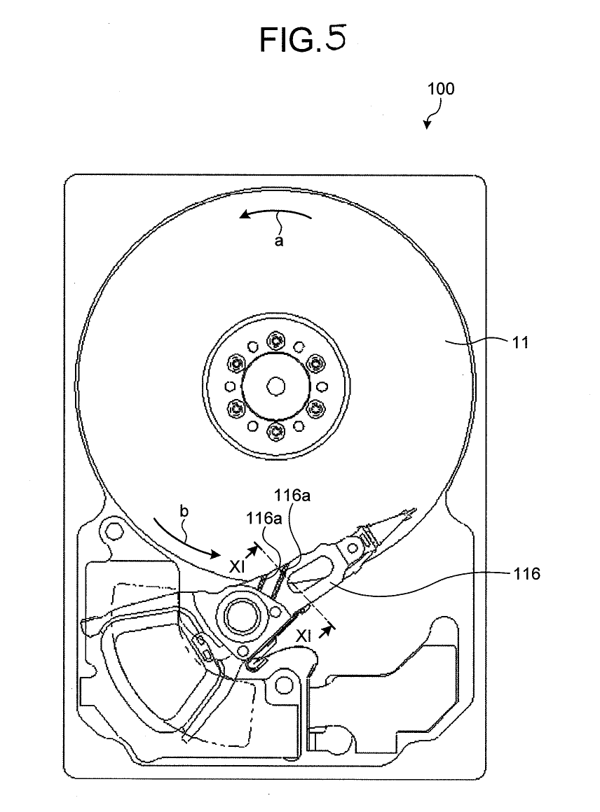

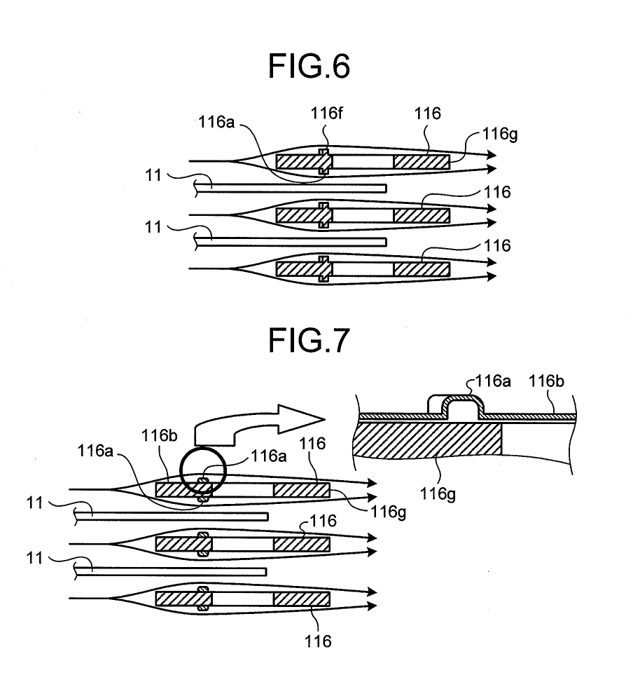

The positioning accuracy of the head 18 by the actuator arm 16 of the first embodiment will now be explained. FIG. 3 is a graph indicating experiment results related to the accuracy of the head positioning by the actuator arm. FIG. 4 is a schematic diagram for explaining the experiment results related to the accuracy of the head positioning by the actuator arm. FIG. 5 is a schematic diagram of a disk recording device according to a second comparative example. FIG. 6 is a cross-sectional view taken along a line XI-XI in FIG. 5. FIG. 7 is a cross-sectional view of a modification of the second comparative example.

In the experiment, an asynchronous component is validated between the positioning accuracy of the head 18 and the disk rotation for each of the cylinders of the disk recording medium 11 as illustrated in FIGS. 3 and 4. In the experiment, the actuator arm of the first embodiment is compared with those of first and second comparative examples. An actuator arm of the first comparative example has a conventional structure (not illustrated) having no protrusions. An actuator arm of the second comparative example is an actuator arm 116 in a disk recording device 100 illustrated in FIGS. 5 and 6. The actuator arm 116 of the second comparative example has a structure in which long protrusions (steps) are arranged on the top and bottom outer surfaces in a direction almost perpendicular to the flowing direction of the air flow. These protrusions 116a are formed integrally with a base body 116g, or arranged on a plate member 116b that is a member separate from the base body 116g as illustrated in FIG. 7. FIGS. 1 and 5 illustrate the magnetic disk recording device in which the head is positioned near the outer circumference of the disk recording medium 11 where the speed of the air flow (flow rate) is high and the influence of the air disturbance is the greatest. In FIGS. 2, 6 and 7, the air flow generated when the disk recording medium 11 rotates is indicated with an arrow.

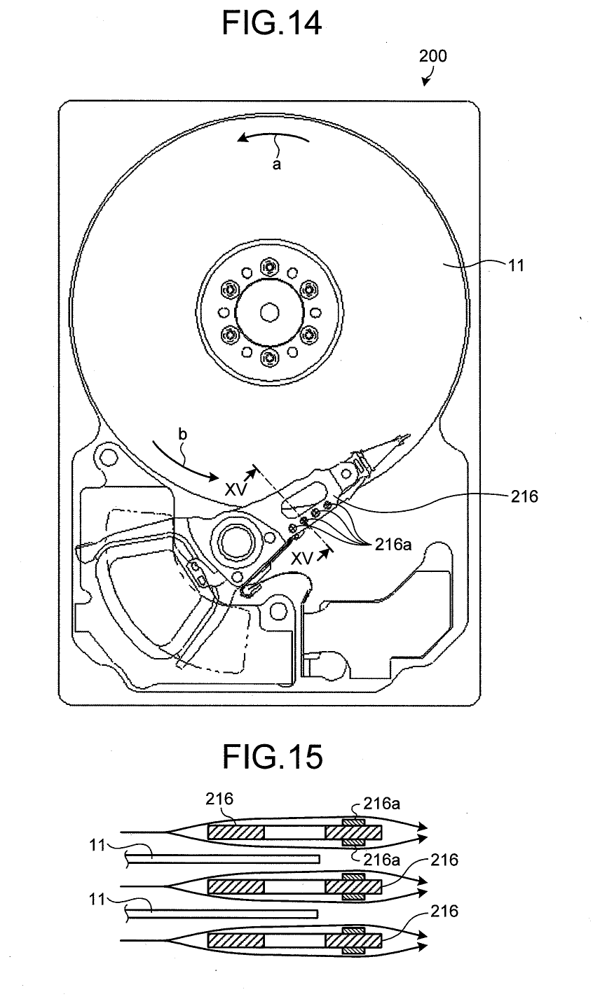

In the experiment, as indicated in FIGS. 3 and 4, with the actuator arm 16 of the first embodiment, the positioning accuracy of the head 18 is improved across the entire cylinder areas compared to the first comparative example. i.e., a conventional example. On the contrary, with the actuator arm of the second comparative example, the positioning accuracy of the head 18 is improved only when the head 18 is located near the outer circumference of the disk recording medium 11 compared to the first comparative example, i.e., a conventional example. In other words, the actuator arm of the second comparative example can achieve an improvement when the head 18 is located near the outer circumference of the disk recording medium 11, but degrades the positioning accuracy, although in a small degree, when the head 18 is located at the inner side thereof. On the other hand, the actuator arm 16 of the first embodiment achieves greater improvement than that the second comparative example does with respect to the first comparative example. Further, according to the first embodiment, the positioning accuracy of the head 18 improves more than that of the second comparative example in the average. Although not indicated in FIGS. 3 and 4, an experiment was conducted also with a conventional actuator arm 216 illustrated in FIG. 14. The results indicate, that an improvement in the positioning accuracy of the head 18 achieved by the actuator arm 216 remains only approximately 2 percent with respect to the first comparative example near the outer circumference of the disk recording medium 11 where the speed of the air flow is high and the influence of the air disturbance is at the greatest.

As described above, according to the first embodiment, the linear protrusions 16f are arranged at the edges 16e of the outer surfaces 16c and 16d located upstream in the direction of the air flow (arrow b) generated by the rotation of the disk recording medium 11. The linear protrusions 16f extend along the edges 16e. Therefore, the vibration of the actuator arm 16, caused by the air flow generated by the rotation of the disk recording medium 11, can be suppressed more compared to the conventional structures, and thereby the positioning accuracy of the head 18 can be further improved. Thus, the high speed and the high performance disk recording device 10 can be realized.

Moreover, according to the first embodiment, the linear protrusions 16f are arranged on both the outer surfaces 16c and 16d. With this, the positioning accuracy of the head 18 can be improved more than a structure in which the linear protrusion 16f is arranged only on one of the outer surfaces 16c and 16d.

Furthermore, according to the first embodiment, the extension 16b comprises the base body 16g formed integrally with the joint 16a, forming the arm main body 16h together with the joint 16a, and the plate members 16i that are fixed onto the base body 16g. The linear protrusions 16f are formed integrally with the plate member 16i. Therefore, a conventional arm main body can be used without large modification thereto.

First to fourth modifications of the first embodiment will now be explained.

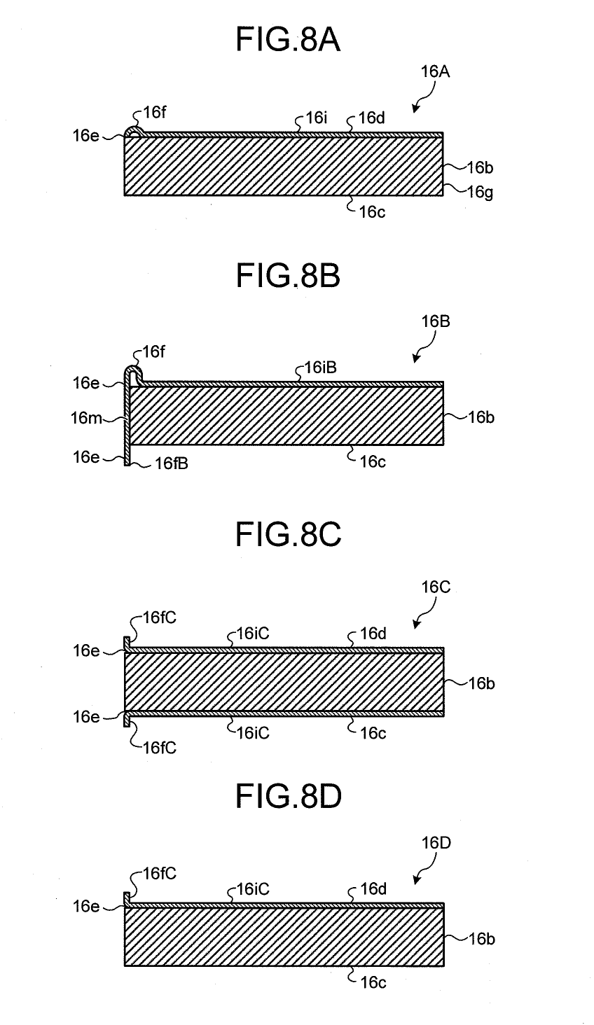

FIG. 8A is a cross-sectional view of an actuator arm according to the first modification. In an actuator arm 16A of the first modification illustrated in FIG. 8A, the plate member 16i arranged on the base body 16g is only one. With such a structure, the linear protrusion 16f arranged on the actuator arm 16A is only one.

In such a structure, because the plate member 16i is only one, the cost of the actuator arm 16A can be reduced compared to the structure having two plate members 16i.

FIG. 8B is a cross-sectional view of an actuator arm according to the second modification. In an actuator arm 16B of the second modification illustrated in FIG. 8B, only one plate member 161B is arranged on the base body 16g. The plate member 161B is formed in an L-like shape, and covers an upstream side surface 16m of the base body 16g, with a tip end thereof protruding from the base body 16g. The linear protrusion 16f is formed as a bent portion of the plate member 161B, and a linear protrusion 16fB is formed at the tip end thereof.

In such a structure, because the two linear protrusions 16f and 16fB are formed from the single plate member 161B, a cost reduction as well as an improvement in the positioning accuracy of the head 18 can be achieved.

FIG. 8C is a cross-sectional view of an actuator arm according to the third modification. In an actuator arm 16C of the third modification illustrated in FIG. 8C, edges of plate members 16iC are formed to bend approximately 90 degrees to form linear protrusions 16fC. In the third modification, two of the plate members 16iC are arranged, and the two linear protrusions 16fC are arranged.

In such a structure, the linear protrusions 16fC can be formed relatively easily.

FIG. 8D is a cross-sectional view of an actuator arm according to the fourth modification. In an actuator arm 16D of the fourth modification illustrated in FIG. 8D, the plate member 161C explained in the third modification is only one, and the linear protrusion 16fC is only one.

In such a structure, not only the linear protrusion 16fC can be formed relatively easily, but also the cost can be reduced because only one plate member 161C is present.

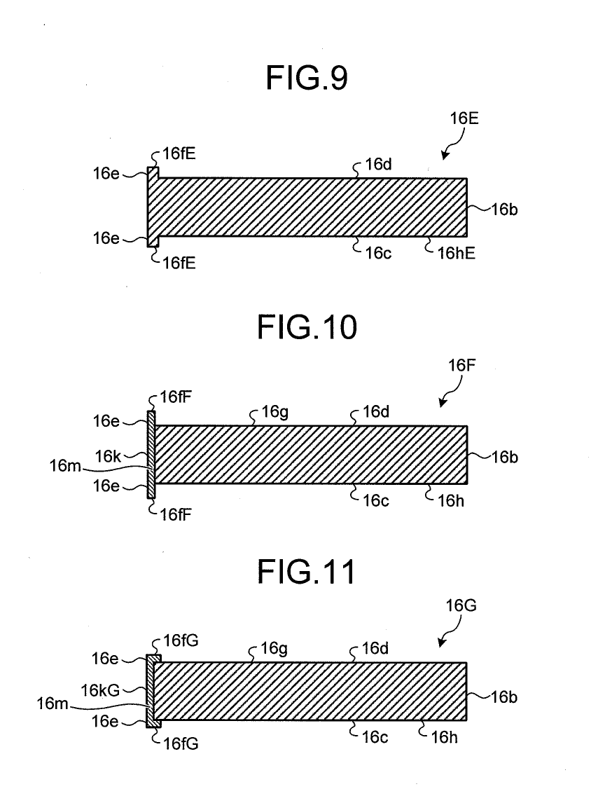

FIG. 9 is a cross-sectional view of an actuator arm according to a second embodiment of the invention. The second embodiment is basically the same as the first embodiment except that linear protrusions 16fE are integrally formed with an arm main body 16hE in an actuator arm 16E.

More specifically, the actuator arm 16E of the second embodiment does not have the plate members 16i of the first embodiment. The extension 16b is formed integrally with the joint 16a, forming the arm main body 16hE together with the joint 16a, and the linear protrusions 16fE are formed integrally with the arm main body 16hE. In this manner, steps are formed on the arm main body 16hE. The height of the linear protrusions 16fE is, for example, 150 micrometers.

As explained above, according to the second embodiment, the linear protrusions 16fE are formed integrally with the arm main body 16hE. Thus, the structure of the actuator arm 16E can be simplified.

FIG. 10 is a cross-sectional view of an actuator arm according to a third embodiment of the invention. The third embodiment is basically the same as the first embodiment except for a plate member 16k in place of the plate members 16i of the first embodiment.

In an actuator arm 16F of the third embodiment, similar to the first embodiment, the extension 16b has the base body 16g that is integrally formed with the joint 16a, forming the arm main body 16h together with the joint 16a. In the third embodiment, the extension 16b has the plate member 16k that is fixed to the upstream side surface 16m of the base body 16g at upstream in the flowing direction of the air flow (the arrow b in FIG. 1). Linear protrusions 16fF are comprised in the plate member 16k. More specifically, the height of the plate member 16k is set higher than the thickness of the base body 16g. The plate member 16k is fixed to the base body 16g so that upper and lower ends thereof protrude from the base body 16g. The protrusions formed by such a structure realize the linear protrusions 16fF.

As described above, according to the third embodiment, the linear protrusions 16fF are formed with the plate member 16k. Thus, the linear protrusions 16fF can be formed in a relatively simple structure.

A modification of the third embodiment will now be explained. FIG. 11 is a cross-sectional view of an actuator arm according to the modification of the third embodiment. In an actuator arm 16G of the modification, the plate member 16kG is formed in a U-like shape, and is engaged with the base body 16g. A pair of upper and lower bent portions of the plate member 16k form linear protrusions 16fG.

In such a structure, the height of the linear protrusion 16fG can be easily controlled with respect to the base body 16g. Thus, better manufacturability can be achieved.

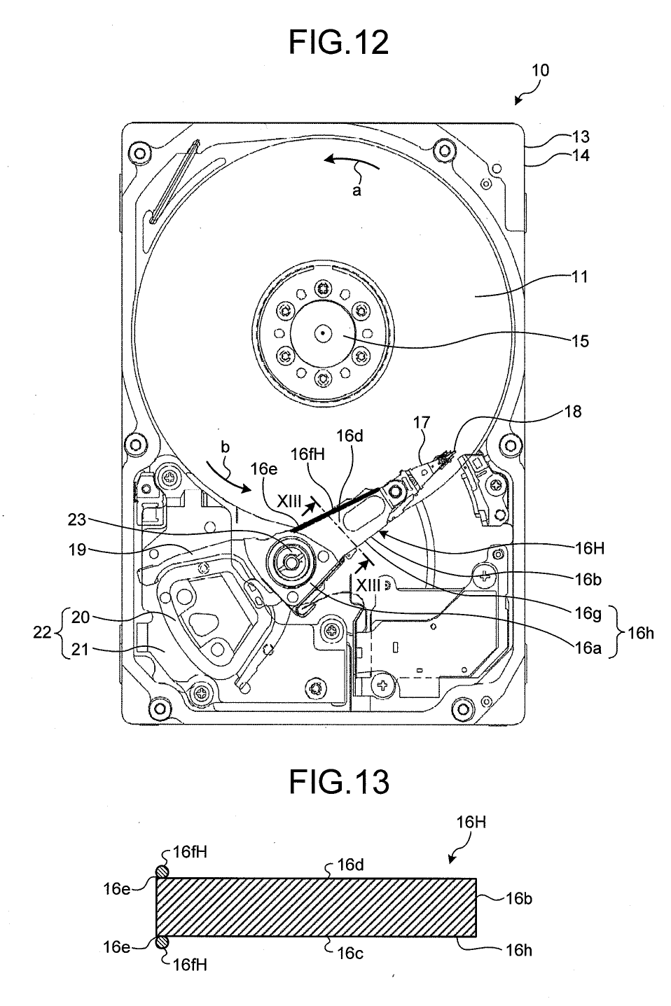

FIG. 12 is a schematic diagram of a disk recording device according to a fourth embodiment of the invention. FIG. 13 is a cross-sectional view taken along a line XIII-XIII in FIG. 12. The fourth embodiment is basically the same as the first embodiment except that linear protrusions 16fH are made of wire rods.

In an actuator arm 16H of the fourth embodiment, the extension 16b is formed integrally with the joint 16a, forming the arm main body 16h together with the joint 16a. Linear protrusions (wire rods) 16fH are fixed to the top and bottom surfaces of the arm main body 16h by, for example, adhesion. The diameter of the wire rod comprising the linear protrusion 16fH is, for example, 100 micrometers.

As explained above, according to the fourth embodiment, the linear protrusions 16fH are made of wire rods fixed to the arm main body 16h. Thus, the linear protrusion 16fH can be formed in a relatively simple structure.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An actuator arm comprising:
a joint configured to be rotatably supported on a shaft;
an extension extending from the joint, the extension comprising a tip end connected to a head configured to perform at least one of reading and writing with respect to a rotating disk recording medium;
a pair of outer surfaces in a front-and-rear relationship with each other, at least one of which is configured to face the disk recording medium; and
a linear protrusion arranged on and extending along an edge of at least one of the outer surfaces, the edge being located upstream on the outer surfaces in a flowing direction of an air flow generated by rotation of the disk recording medium.

2. The actuator arm of claim 1, wherein
the extension comprises
a base body formed integrally with the joint to form an arm main body together with the joint, and
a plate attached to the base body, and
the linear protrusion is formed integrally with the plate.

3. The actuator arm of claim 1, wherein
the extension is formed integrally with the joint to form an arm main body together with the joint, and
the linear protrusion is formed integrally with the arm main body.

4. The actuator arm of claim 1, wherein
the extension further comprises
a base body formed integrally with the joint to form an arm main body together with the joint, and
a plate attached to an upstream side surface of the base body located upstream in the flowing direction of the air flow, and
the linear protrusion is in the plate.

5. The actuator arm of claim 1, wherein
the extension is formed integrally with the joint to form an arm main body together with the joint, and
the linear protrusion comprises a wire rod attached to the arm main body.

6. The actuator arm of claim 1, wherein a height of the linear protrusion is within a range of 50 micrometers to 200 micrometers.

7. A disk recording device comprising:
a disk recording medium;
a disk driver configured to drive the disk recording medium to rotate;
a head configured to perform at least one of reading and writing with respect to the rotating disk recording medium;
an actuator arm connected to the head; and
an arm driver configured to drive the actuator arm to rotate, wherein
the actuator arm comprising
a joint configured to be rotatably supported on a shaft;
an extension extending from the joint;
a pair of outer surfaces in a front-and-rear relationship with each other, at least one of which is configured to face the disk recording medium; and
a linear protrusion arranged on and extending along an edge of at least one of the outer surfaces, the edge being located upstream on the outer surfaces in a flowing direction of an air flow generated by rotation of the disk recording medium.
